(19) United States
(12) Patent Application Publication
(10) Pub. No.: US 2009/0064270 A1
(43) Pub. Date: Mar. 5, 2009

(54) TEMPLATE BASED FEDERATION OF POLICIES

(76) Inventors: Rajeev Gupta, Noida (UP) (IN); Mukesh Kumar Mohania, New Delhi (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/846,623

(22) Filed: Aug. 29, 2007

(51) Int. Cl. H04L 9/00

(52) U.S. Cl. 726/1

(57) ABSTRACT

This disclosure presents a method of federating policies to the underlying policy management systems based on their respective capabilities, a method to federate policies to policy managers when same managed resource is being managed by multiple managers, a method to create and federate policies at lower level policy managers for given policy at higher level integrated policy manager system, and a method to federate policies to autonomic managers using policy templates.

### BACKGROUND AND SUMMARY

The embodiments of the invention generally relate to policy management and more particularly method of federating policies to the underlying policy management systems based on their respective capabilities.

In systems for integrated management of an enterprise wide infrastructure, policies are used for ease of management. These policies are defined at the top level and they need to be translated and executed at appropriate nodes in the infrastructure. In this disclosure we present a method of federating policies to the underlying policy management systems based on their respective capabilities.

Autonomic computing is intended to help systems become self-configuring, self-healing, self-optimizing, and self-protecting. It addresses the issue of providing IT infrastructure that can be managed by non-IT experts without investing manpower for its use, support, maintenance, and management. This allows the IT professional to focus on high-value tasks while the technology manages the more mundane operations.

Autonomic computing systems also have the ability to change in accordance with business objectives. To achieve these business objectives, policies are defined. A policy is a tool to specify the autonomic behavior in complex systems. A policy can provide goals that the system attempts to achieve or actions that the system should take on certain conditions.

Policy scope is used to indicate the target system(s) or managed resources of the policy. These are often a particular class of managed resources with similar attributes. Scopes can be hierarchical such that one scope is a super-set of other possible scopes. For examples, a scope all_databases may encompass all the systems belonging to various scopes like db2, payroll_database, HR_database, etc. Similarly, an enterprise wide policy encompasses policies for various systems in the enterprise.

As shown in FIG. 1, policies are defined and executed using a policy management system having a policy manager 100 (comprising a graphic user interface (GUI) and storage), an autonomic manager 102, and a managed resource 104. Such a system can be integrated with the system being managed or it can be middleware [1] used with managed resources of same or different domains. The policy management system generally has a front-end, which we call as policy manager, comprising a user interface (probably GUI) to define policies, and a storage component to store and federate policies before execution. Another component of the policy management system, which we call the autonomic manager, is responsible for getting policies from the policy manager and executing them on the managed resource. The autonomic manager can be remote from the policy manager module. In a popular scenario, there will be one centralized policy manager, sending policies to a number of remote autonomic managers, which are local to their respective resources being managed.

Thus, in systems for integrated management of enterprise wide infrastructure, policies are used for ease of management. These policies are defined at the top level and they need to be translated and executed at appropriate nodes in the infrastructure. This disclosure presents a method of federating policies to the underlying policy management systems based on their respective capabilities, a method to federate policies to policy managers when the same managed resource is being managed by multiple managers, a method to create and federate policies at lower level policy managers for a given policy at a higher level integrated policy manager system, and a method to federate policies to autonomic managers using policy templates.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a typical policy management system;

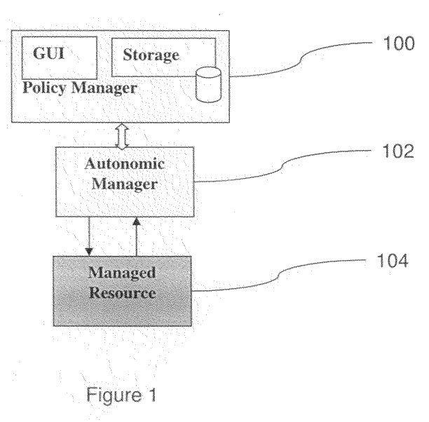

FIGS. 2(a) and 2(b) are examples XML illustrations of policy templates; and

FIG. 3 is a schematic diagram of templates based policy federation according to the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

With respect to policy federation in any enterprise, if there are many managed resources each with their own policy management systems then integrated management of them is essential for meeting the business needs of the enterprise. For example, an enterprise level data storage policy may involve file systems as well as database systems. Both may require different kinds of policies and policy management systems for managing them. Thus, it becomes vital that the enterprise level policy is translated into policies for different managed resources and routed to the corresponding policy managers. Further, different policy management systems, managing the same managed resource may have different capabilities; policy languages used by them may be different, etc. For example, a storage management may be done by Tivoli Storage Manager (TSM) [2] as well as by Tivoli TotalStorage Productivity Center (TPC) [3]. Both products are used to manage enterprise storage systems. TPC can execute archival and back-up of a group of files based on their size and access frequency, whereas TSM will not be able to execute them. In such cases, if a storage policy is defined, then it should be propagated to the appropriate policy management system which can successfully execute the policy. Thus, if a complex policy is defined for storage management, then it should be assigned to TPC.

Policy federation is defined as a process of modifying (and dividing, if required) policies for lower level management systems and routing them to the appropriate system. In this document we present a method of policy routing when multiple policy management systems are used for managing a resource. The problem is how the higher layer policy management system will know of the capabilities of the underlying policy management systems and federate the policies to them. To address such issues, the present invention provides a method through which capabilities of the underlying policy management systems are abstracted out at the higher layer. This abstraction is used by the higher layer policy management system to modify and route a policy to the most appropriate policy management system.

With respect to policy templates, templates are generally used in various domains to help in developing the actual document or showing the typical structure of the document. Policy templates are used by user interfaces of various policy management systems to help users define polices. Templates can be there for, various requirements such as security policy templates, database back-up templates, etc. Templates can be seen as a typical policy with each policy attribute having various possible optional values. By defining templates for a particular scope or group, the policy based system (along with managed resource) guarantees that the policy written using that template can be implemented by the system.

If a policy language used by a certain policy management system has certain capability (e.g. default execution) and the managed resource has a certain interface (e.g. size of used storage) then the policy template can be designed to use those functions and interfaces; whereas, if some other policy management system does not have those capabilities, then its template will be simpler. Here capability of the policy management system is that of its autonomic manager. If there are multiple autonomic managers, possibly with different capabilities, associated with a policy management system; they can be thought of as different policy management systems. While federating a policy, the higher level system needs to ensure that it reaches to the correct autonomic manager. It may be possible that capabilities of a system are not captured by one template; in that case, a group of templates can be used.

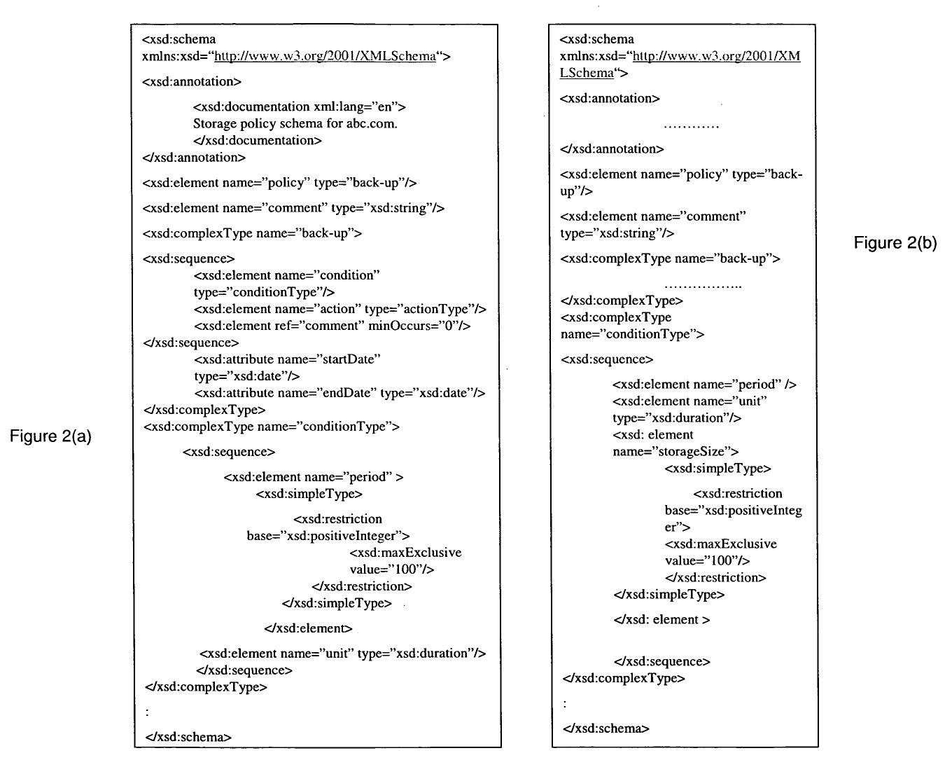

FIGS. 2(a) and 2(b) show examples of policy templates for data back-up operations in pseudo-code format. In FIG. 2(a), the policy management system can perform storage related operations given a start-date, end-date, and period of performing the operation. Thus, it can perform operations only on a periodic basis rather then, say, when the storage size crosses a certain limit. Conditional execution, based on storage usage, can be performed by the management system represented by the template shown in FIG. 2(b).

With respect to policy federation using templates, as explained in the previous section, policy templates can be used to describe capabilities of a policy manager along with its managed resource. Although our scheme can be extended to any general representation of policy template, for the ease of explaining, we assume that the policy template follows a certain XML language format. A policy can be written using a template by replacing the value type with the value. For example, the template shown in FIG. 2(a) can be converted into a policy by inputting the appropriate period, action, startDate, and endDate.

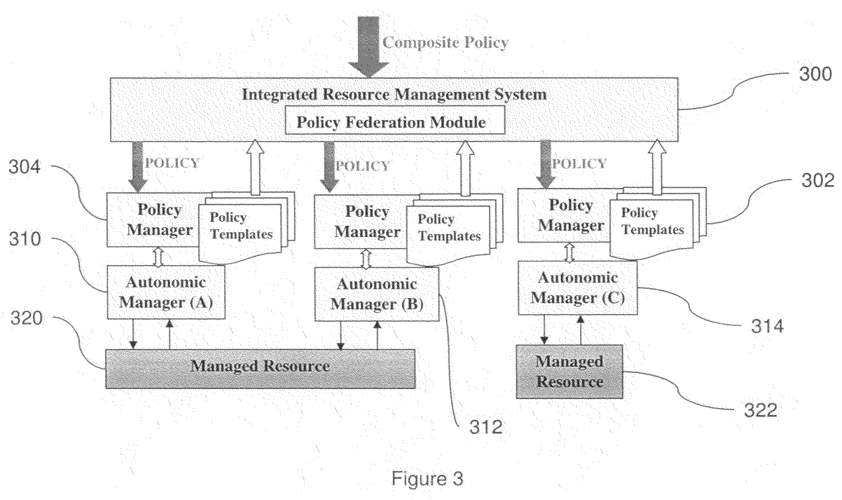

We present methods covering three aspects of policy federation. The first is dividing an integrated policy at higher layer into a number of policies of individual underlying management systems. The second is routing policies based on capabilities of the underlying policy management systems. The third is keeping policies refreshed at possibly remote autonomic managers using policy templates. FIG. 3 gives a schematic of policy federation using templates.

If a policy is defined for the integrated management system, we present a method to route the policy to underlying policy management systems. More specifically, as shown in FIG. 3, the invention provides an integrated resource management system 300 that includes a policy federation module. The system 300 provides policies to each different policy manager 304. As explained earlier, each policy manager 304 is associated with a set of policy templates 302 signifying their capabilities.

First let us consider the case where the same managed resource 320 is being managed by multiple autonomic managers 310 (A) and 320 (B) in FIG. 3 (as opposed to the one-to-one case shown with manager 314 and resource 322). In that case, the input policy is forwarded to the most suitable policy management system without any logical transformations. For finding out the policy management system to federate, we use an XML schema matching tool [4] to match the given policy with the set of policy templates for each policy management system. This matching ensures that the incoming policy can be created using the particular template. As these templates are capability templates, if the policy matches with any one of the policy templates, the policy can be executed by that policy management system. Even if the policy matches a sub-set of the template (i.e. using only some of the tags/functions specified in the template), it is considered matched. If the policy is matched by more than one policy management system, then the suitable system can be chosen randomly or by using some other criterion, such as load on the system, most limiting template etc.

In the case where the integrated resource management system receives a policy which requires routing to more than one managed resource, the policy federation involves creation of policies for individual policy management systems; and routing the policies to the appropriate policy management system. Both the objectives can be fulfilled using policy templates. Assuming, on the integrated management system, that all the policies are defined using previously decided templates, for each template at the higher level manager there are corresponding templates for lower level managers and an XSL style sheet for mapping values from higher level policies to lower level.

For example, a higher level template for storage management may have some indicative function for storage-size. In the lower level, database and file systems, storage-size may be indicated by table_size and directory_size variables. This variable mapping is performed by the XSL stylesheet. From these style-sheets, we obtain policies for lower level policy management systems and managed resources. Those policies can be routed and executed at the lower level systems. If a managed resource is being managed by multiple policy management system, then the method explained in the previous section can be used to route the generated policies.

Another scenario of template based policy federation arises in distributed policy management systems where a policy manager federate policies to multiple, possibly remote, autonomic managers based on the managed resources they are managing. In such a scenario, the policy manager can be common across multiple autonomic managers managing possibly different managed resources or different operations of the similar managed resource. The policy manager publishes the policy templates across various domains. Each autonomic manager can select the templates it is “interested in” using the types of policies it can execute. For example, an autonomic manager AM1 can execute back-up policies while AM2 can execute archival policies. These different kinds of policies can be represented using different templates. Then AM1 will subscribe to a back-up template whereas AM2 will subscribe to archival template. Whenever a new policy is defined at the policy manager, it is sent to all the autonomic managers who have registered their interest in the template which the policy is following. Similar messages can be sent for update and delete of a policy belonging to a particular template.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

### REFERENCES

[1]. “Policy Management for Autonomic Computing” http://www.alphaworks.ibm.com/tech/pmac: This gives an example of policy management system which can be used as policy manager and autonomic manager.
[2]. “IBM Tivoli Storage Manager” http://www-306.ibm.com/software/tivoli/products/storage-mgr/
[3]. “IBM Total Storage Productivity Center for Data (TPC-data)” http://www-306.ibm.com/software/tivoli/products/totalstorage-data/
[4]. “Generating XSL for Schema Validation” www.redrice.com/ci/generatingXslValidators.html: This gives an example for automated schema validations. It uses XSL style-sheet for checking whether an XML document conforms to a given DCD schema document.

What is claimed is:

1. A method of federating policies to underlying policy management systems based on respective capabilities of said policy management systems, said method comprising:
dividing an integrated policy at a higher level policy manager into a number of federated policies of individual underlying management systems at relatively lower layers of policy managers;
routing said federated policies based on respective capabilities of said underlying policy management systems; and
keeping said federated policies refreshed at remote autonomic managers using policy templates.

2. The method according to claim 1, wherein when a same managed resource is managed by multiple managers having different capabilities, an input policy is forwarded to the most suitable policy management system without any logical transformations.

3. The method according to claim 1, wherein when an integrated resource management system receives a policy which requires routing to more than one managed resource, said method further comprises:
creating new policies for individual policy management systems using said policy templates; and
routing said new policies to their corresponding policy management systems.

4. The method according to claim 1, wherein when a policy manager federates policies to multiple remote autonomic managers based on managed resources said autonomic managers are managing, said policy manager is common across multiple ones of said autonomic managers managing one of different managed resources and different operations of similar managed resource,
wherein said method further comprises publishing, by said policy manager, said policy templates across various domains, and
wherein each said autonomic manager has an option to select templates based on interest and types of policies said autonomic manager can execute.

5. The method according to claim 1, wherein said policy templates describe capabilities of a policy manager along with its managed resource, wherein said templates comprise a policy having attributes, wherein each attribute has various possible optional values.

6. A method of federating policies to underlying policy management systems based on respective capabilities of said policy management systems, said method comprising:
dividing an integrated policy at a higher level policy manager into a number of federated policies of individual underlying management systems at relatively lower layers of policy managers;
routing said federated policies based on respective capabilities of said underlying policy management systems; and
keeping said federated policies refreshed at remote autonomic managers using policy templates, wherein said templates comprise a policy having attributes, wherein each attribute has various possible optional values.

7. The method according to claim 6, wherein when a same managed resource is managed by multiple managers having different capabilities, an input policy is forwarded to the most suitable policy management system without any logical transformations.

8. The method according to claim 6, wherein said templates describe capabilities of a policy manager along with its managed resource.

9. The method according to claim 6, wherein when an integrated resource management system receives a policy which requires routing to more than one managed resource, said method further comprises:
creating new policies for individual policy management systems using said policy templates; and
routing said new policies to their corresponding policy management systems.

10. The method according to claim 6, wherein when a policy manager federates policies to multiple remote autonomic managers based on managed resources said autonomic managers are managing, said policy manager is common across multiple ones of said autonomic managers managing one of different managed resources and different operations of similar managed resource,
wherein said method further comprises publishing, by said policy manager, said policy templates across various domains, and
wherein each said autonomic manager has an option to select templates based on interest and types of policies said autonomic manager can execute.
